(19) United States
(12) Patent Application Publication
(10) Pub. No.: US 2007/0109589 A1
(43) Pub. Date: May 17, 2007

(54) Network terminal device and method for managing equipment by using web technology

(76) Inventor: Akira Yokoyama, Saitama (JP)

Correspondence Address: COOPER & DUNHAM, LLP, 1185 AVENUE OF THE AMERICAS, NEW YORK, NY, 10036, US

(21) Appl. No.: 10/913,774

(22) Filed: Aug. 6, 2004

(30) Foreign Application Priority Data
Aug. 7, 2003 (JP) 2003-289310

(51) Int. Cl. G06F 3/12

(52) U.S. Cl. 358/1.15; 358/400

(57) ABSTRACT

A network terminal device having a Web service function includes means for providing a Web page to a user via a network, and means for providing a Web service using SOAP to the user via the network. The network terminal device may have a system structure including a first service layer for managing a hardware of a machine, an application layer for providing an operations display function of the machine to the user by using the first service layer, and a second service layer having a function call conforming to a SOAP schema or a program interface to the application layer.

### BACKGROUND OF THE INVENTION

1. Field of the Invention

The present invention relates to network terminal devices having Web service functions and a method for managing equipment by using Web technology.

2. Description of the Related Art

Generally, a variety of devices, particularly office equipment such as printers, fax machines, and copiers, have device specific user interface functions including light emitting elements such as LEDs or LCDs, various kinds of input buttons or switches, and others.

Related art Japanese Laid-Open Patent Application No. 10-149270 discloses a network terminal device wherein office equipment can be connected to a network so that an operator can access the equipment from another terminal device such as a personal computer. In the above network terminal device, a Web access mechanism is provided inside of the equipment. The equipment has an enhanced and widely accessible user interface function wherein Web technology is used.

The user interface function wherein the Web technology is used is realized by using a process, a memory, an input/output circuit, or the like which is already installed inside of the machine. Therefore, the user interface function has an advantage in that extra cost or space for the Web server function is not required.

Accordingly, at present, most network terminal devices have functions whereby information retained by the network terminal devices per se or external devices is provided to users as a Web page for a general purpose Web blower.

On the other hand, in companies or others, there is a strong demand that a lot of office equipment such as printers, fax machines, or copiers are managed in a lump by use of exclusive managing software by a manager. Because of this, equipment whereby information retained by the equipment per se or an external device is provided to an external part by using technology such as SNMP (Simple Network Management Protocol) or XML (Extensible Markup Language), is also provided.

Means for providing a function to manage a device by using XML is called a Web service and used for a variety of purposes including for the office equipment.

Furthermore, a service is provided from certain equipment to other equipment by the Web service. Hence, units of the Web service vary and therefore there are a variety of Web services.

Accordingly, a user of the Web server can develop software realizing various processes by combining services to be used.

On the other hand, there is a demand that a general user of the equipment be able to manage the equipment by using an all-purpose Web browser without installing the exclusive managing software on the personal computer used by the general user.

Generally, a Web page is described by HTML (Hyper Text Markup Language). Normally, the Web page has a form different from the XML data used between the equipment and the software at the user side and for managing the equipment.

Furthermore, SNMP is a technology totally different from HTML and XML. The SNMP has no relationship with technology for describing the Web page.

Hence, there is a problem in that a function for providing a Web page for a Web browser and a function for communicating by SNMP/XML for the exclusive managing software have to be designed and installed completely separately for preparing both functions to manage equipment by using the Web technology.

An operations panel provided for the device has a function to provide the user interface and mostly depends on hardware forming the device. Hence, it is normal to install the operations panel completely separately from the user interface function wherein the above-discussed Web technology is used. Because of this, the structure of the software becomes complex and a lot of resources such as ROM or RAM necessary for operating the software are required.

To solve the above-discussed problems, the related art Japan Laid-Open Patent Application 2000-76036 discloses a method for providing a user interface at the operations panel based on data described in HTML.

However, in this method, it is required to install not only the Web server function but also the Web browser function in the device.

In a case where the Web browser function is not originally installed because there is no necessity to directly print an HTML file, for example, a large amount of software is required and therefore it is difficult to develop and install the software. Accordingly, a lot of resources for operating the software such as ROM or RAM are required.

In a case where it is necessary to display images having the same contents on the operations panel and a computer connected to a network, a single HTML data set should be prepared for being used commonly. However, in a case where it is necessary to drastically change a layout or a difference occurs in displayed contents, the HTML data set is required to be made separately. Hence, the degree of freedom for developing the software is not high.

### SUMMARY OF THE INVENTION

Accordingly, it is a general object of the present invention to provide a novel and useful network terminal device and method for managing equipment by using Web technology, in which one or more of the problems described above are eliminated.

Another and more specific object of the present invention is to provide a network terminal device whereby the workload on the device can be lightened and a flexible user interface can be realized and a method for providing a Web service.

The above object of the present invention is achieved by a network terminal device having a Web service function, including:

means for providing a Web page to a user via a network; and

means for providing a Web service using SOAP to the user via the network.

The above object of the present invention is also achieved by a network terminal device having a Web service function, including:

user interface function means for providing an operations display function to a user via a network; and

means for providing a Web page via the network.

The above object of the present invention is also achieved by a network terminal device having a Web service function, including:

user interface function means for providing an operations display function to a user via a network; and

means for providing a Web service using SOAP to the user via the network.

The above object of the present invention is also achieved by a network terminal device having a Web service function, including:

user interface function means for providing an operations display function to a user via a network;

means for providing a Web page to the user via the network; and

means for providing a Web service using SOAP to the user via the network.

The above object of the present invention is achieved by a network terminal device having a Web service function, including:

a Web page providing part configured to provide a Web page to a user via a network; and

a Web service providing part configured to provide a Web service using SOAP to the user via the network.

The above object of the present invention is achieved by a network terminal device having a Web service function, including:

a user interface functional part configured to provide an operations display function to a user via a network; and

a Web page providing part configured to provide a Web page via the network.

The above object of the present invention is achieved by a network terminal device having a Web service function, including:

a user interface functional part configured to provide an operations display function to a user via a network; and

a Web service providing part configured to provide a Web service using SOAP to the user via the network.

The above object of the present invention is also achieved by a network terminal device having a Web service function, including:

a user interface functional part configured to provide an operations display function to a user via a network;

a Web page providing part configured to provide a Web page to the user via the network; and

a Web service providing part configured to provide a Web service using SOAP to the user via the network.

The above object of the present invention is also achieved by a method for managing equipment by using a Web technology, including the steps of:

a) providing a Web page to a user via a network; and

b) providing a Web service using SOAP to the user via the network.

The above object of the present invention is also achieved by a method for managing equipment by using a Web technology, including the steps of:

a) providing an operations display function to a user via a network; and

b) providing a Web page via the network.

The above object of the present invention is also achieved by a method for managing equipment by using a Web technology, including the steps of:

a) providing an operations display function to a user via a network; and

b) providing a Web service using SOAP to the user via the network.

The above object of the present invention is achieved by a method for managing equipment by using a Web technology, including the steps of:

a) providing an operations display function to a user via a network;

b) providing a Web page to the user via the network; and

c) providing a Web service using SOAP to the user via the network.

According to the above-mentioned inventions, in a variety of devices including an operation panel configured to display text or an image and a user interface function wherein a Web technology is used, it is possible to obtain the information about the device and operate to change the settings by using an all-purpose Web browser without installing exclusive software at a place remote from the device.

Furthermore, it is possible to meet the demands of the user such as a managing person who likes to manage in detail from a place remote from the device by providing exclusive client software.

In addition, it is possible for the user to individually develop the client software for operating the device.

Other objects, features, and advantages of the present invention will become more apparent from the following detailed description when read in conjunction with the accompanying drawings.

### BRIEF DESCRIPTION OF THE DRAWINGS

FIG. 1 is a block diagram showing a network system of an embodiment of the present invention;

FIG. 2 is a block diagram showing an example of a structure of a network fax machine FX;

FIG. 3 is a schematic view showing an example of a structure of an operations display part 7;

FIG. 4 is a block diagram showing an example of a system structure of the network fax machine FX;

FIG. 5 is a timing chart showing an example of a sequence of an operation of software inside of the device and a Web browser at the user side, in a case where the Web page to be provided is a page where a list of the communications history of the fax machine is described;

FIG. 6 is a timing chart showing an example of a sequence of an operation of the software inside of the device and managing software at the user side, in a case where the Web service to be provided has a function to provide communications history information of the fax machine;

FIG. 7 shows examples of a request message (SOAP schema 1) sent from the user side to the device, a response message (SOAP schema 2) from the device to the user side, and a command (program interface) that a service layer provides to an application layer described in a function format of the C language; and

FIG. 8 is a timing chart showing an example of a sequence of an operation of fax application 20c, system service 20f, and fax service 20i in a case where the fax application 20c shows communications history information as a part of a function of the fax application 20c.

### DETAILED DESCRIPTION OF THE PREFERRED EMBODIMENTS

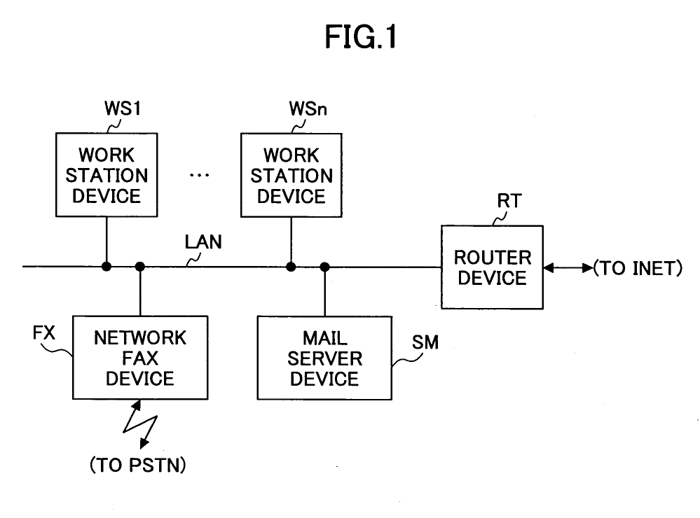

A description of a network terminal device and method for managing equipment by using Web technology, is given below with reference to the FIGS. 1 through 8 of embodiments of the present invention.

FIG. 1 is a block diagram showing a network system of an embodiment of the present invention.

Referring to FIG. 1, a plurality of work stations WS1 through WSn, a mail server device SM, and a network fax machine FX are connected to a local area network LAN. The LAN is connected to the Internet via a router device RT. Therefore, the work stations WS1 through WSn, the mail server device SM, and the network fax machine FX can exchange data with other terminal devices via the Internet.

The mail server SM provides a service of receiving or sending e-mails, to a user using the work station devices WS1 through WSn connected to the local area network LAN and the network fax machine FX. A variety of programs such as software for exchanging various data via the local area network LAN, for example a Web browser, are installed in the work station devices WS1 through WSn. The programs are used by a specific user. Here, the specific user may be single or plural.

The network fax machine FX has an e-mail process function for exchanging image information or various reports as an e-mail, a facsimile communication function for transmitting image information based on a group 3 facsimile transmitting process by using an analog public switched telephone network PSTN as a transmission line, a network printer function for providing a printing function to an external device connected via the local area network LAN, a copy function, and others. That is, this networks fax machine FX works as a multiple function machine corresponding to a network connection.

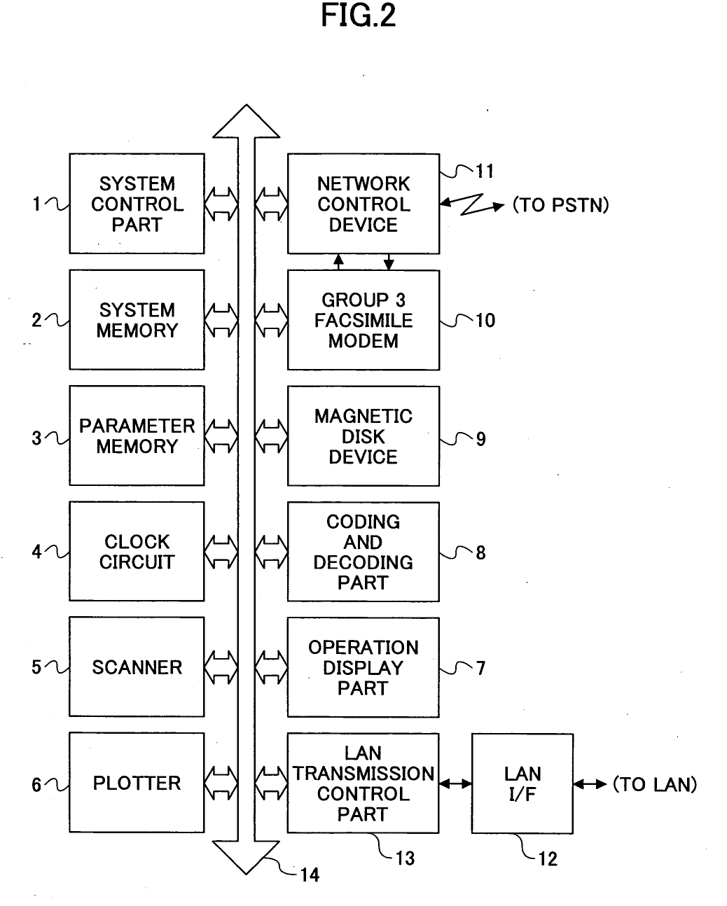

FIG. 2 is a block diagram showing an example of a structure of the network fax machine FX.

Referring to FIG. 2, a system control part 1 performs various control processes such as a control process for parts of the network fax machine FX, a facsimile transmitting step process, a copy function control process, and a network printer function control process. A system memory 2 holds various data necessary for performing a process program and a control process program performed by the system control part 1. The system memory 2 forms a work area for the system control part 1. A parameter memory 3 stores various information characteristic of the network fax machine FX. A clock circuit 4 outputs information about the present time.

A scanner 5 reads out a manuscript image with a designated resolution. A plotter 6 records and outputs an image with a designated resolution. An operation display part 7 works for operating the fax network fax machine FX and includes various operation keys and displays.

A coding and decoding part 8 codes and compresses an image signal and decodes the coded and compressed image signal to an original image signal. A magnetic disk device 9 as an image storage device memorizes various information such as image information (image data) in a coded and compressed state, various data files, and a program data file.

The group 3 facsimile modem 10 realizes a modem function of a group 3 facsimile. The group 3 facsimile modem 10 includes a low speed modem function (V.21 modem) for exchanging a transmitting step signal and a high speed modem function (V.17 modem, V.34 modem, V.29 modem, V.27ter modem, for example) for mainly exchanging image information.

A network control device 11 connects the network fax machine FX to the analog switched telephone network PSTN. The network control device 11 has an automatic incoming and outgoing call function.

A local area network interface circuit 12 connects the network fax machine FX to the local area network LAN. A local area network transmitting control part 13 realizes a communication control process of various and designated protocol suites for exchanging various data with other data terminal devices via the local area network LAN.

The system control part 1, the system memory 2, the parameter memory 3, the clock circuit 4, the scanner 5, the plotter 6, the operations display part 7, the coding and decoding part 8, the image storage device 9, the group 3 facsimile modem 10, the network control device 11, and the local area network transmitting control part 13 are connected to an internal bus 14. Data exchanges in the above elements are performed mainly via the internal bus 14.

Data are directly exchanged between the network control device 11 and the group 3 facsimile modem 10.

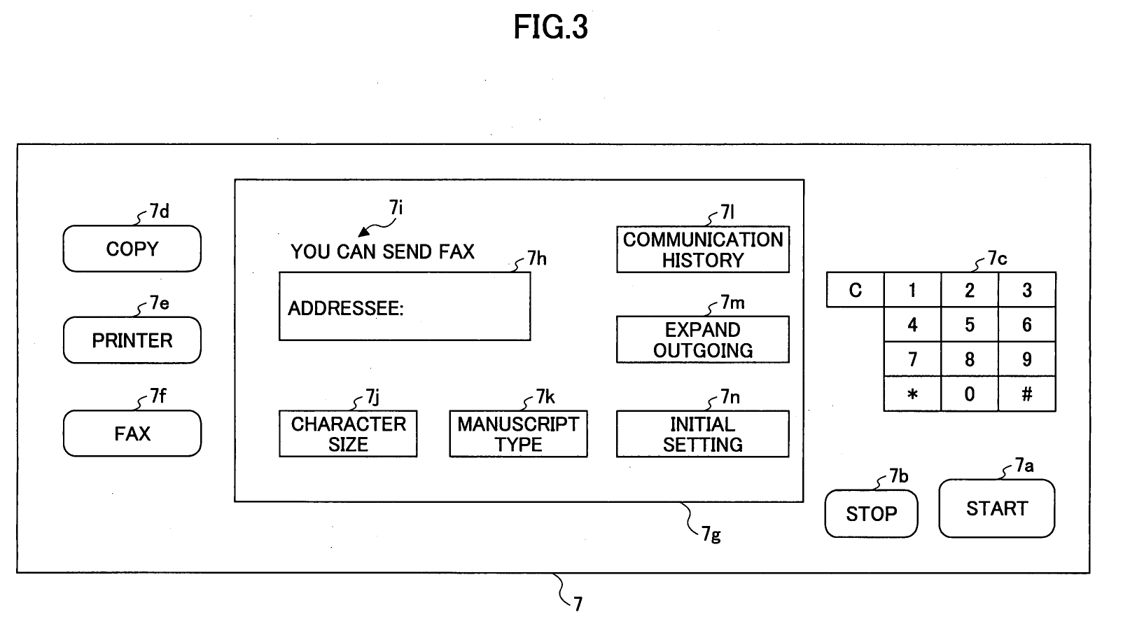

FIG. 3 is a schematic view showing an example of a structure of an operations display part 7.

Referring to FIG. 3, a start key 7a is used for inputting an order operation about the start of facsimile incoming and outgoing operations or copying operations. A stop key 7b is used for inputting an order operation about stopping of operations being executed. A ten key 7c is used for inputting numerical value information of addressee's telephone number or the number of copies, for example.

A copy mode key 7d is used for inputting an order operation so that the network fax machine FX performs copy mode operations. A printer mode key 7e is used for inputting an order operation so that the network fax machine FX performs printer mode operations. A fax mode key 7e is used for inputting an order operation so that the network fax machine FX performs fax mode operations.

A liquid crystal display device 7g having a touch panel displays an operations display window 7h, a message display area 7i, a character size button 7j a manuscript type button 7k, a communications history button 7l, an expand outgoing button 7m, and an initial setting button 7n. The liquid crystal display device 7g detects the fact that the character size button 7j, the manuscript type button 7k, the communications history button 7l, the expand outgoing button 7m, and the initial setting button 7n are ON-operated.

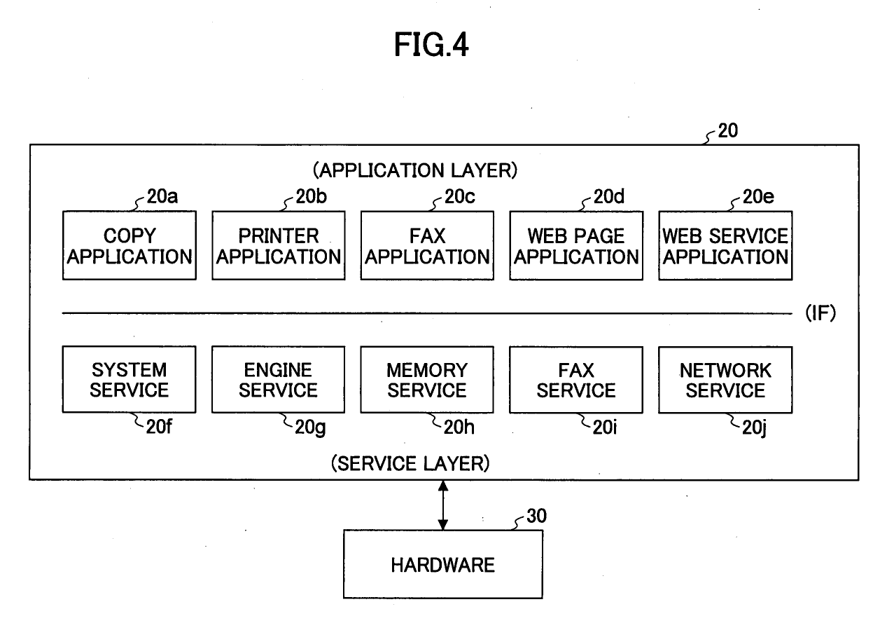

FIG. 4 is a block diagram showing an example of a system structure of the network fax machine FX.

Referring to FIG. 4, the system of the network fax machine FX includes a software block 20 and a hardware block 30.

The software block 20 includes an application layer and a service layer. Each element of the application layer can properly use each element of the service layer via a proper interface mechanism IF.

The application layer includes a copy application 20a for realizing the copy mode operation, a printer application 20b for realizing the printer mode operation, a fax application 20c for realizing the fax mode operation, a Web page application 20d for providing a service of a Web page, and a Web service application 20e for realizing a designated Web service.

Each service forming the service layer manages an element of the hardware block 30 and provides each function to the elements of the application layer. A system service 20f manages the whole of the device including the operations display part 7. An engine service 20g manages the scanner 5 and the plotter 6. A memory service 20h manages a storage device such as the system memory 2, the parameter memory 3, and the magnetic disk device 9. A fax service 20i manages elements of the fax machine such as the group 3 facsimile modem 10 and the network control device 11. A network service 20j manages the local area network transmitting control part 13, for example.

Each application provides a user interface of the operations panel 7 of the device to the user by using the functions of the hardware block 30 via each service.

In a case of a relatively large size device such as the multi-functional device in this embodiment, each application and each service may be operated as separated processes so that mutual communications can be done by using communications between the processes. However, in a case of a device having a relatively small system, the application and the service can be used as modules having different roles in a same process.

For example, the operations display part 7 is managed by the system service 20f. The copy application 20a, the printer application 20b and the fax application 20c receive, from the system service 20f, notice of the information that input from an application switch button (the copy mode key 7d, the printer mode key 7e, and the fax mode key 7f) or a touch panel of the liquid crystal display 7g having the touch panel is performed.

The copy application 20a, the printer application 20b and the fax application 20c display text or an image at the liquid crystal display 7g having the touch panel by ordering the system service 20f.

Meanwhile, the Web page service 20d provides a Web page, which can display a state of the device or perform various settings, to the Web browser contained in a user operating device such as a personal computer, by using the network service 20j and other services.

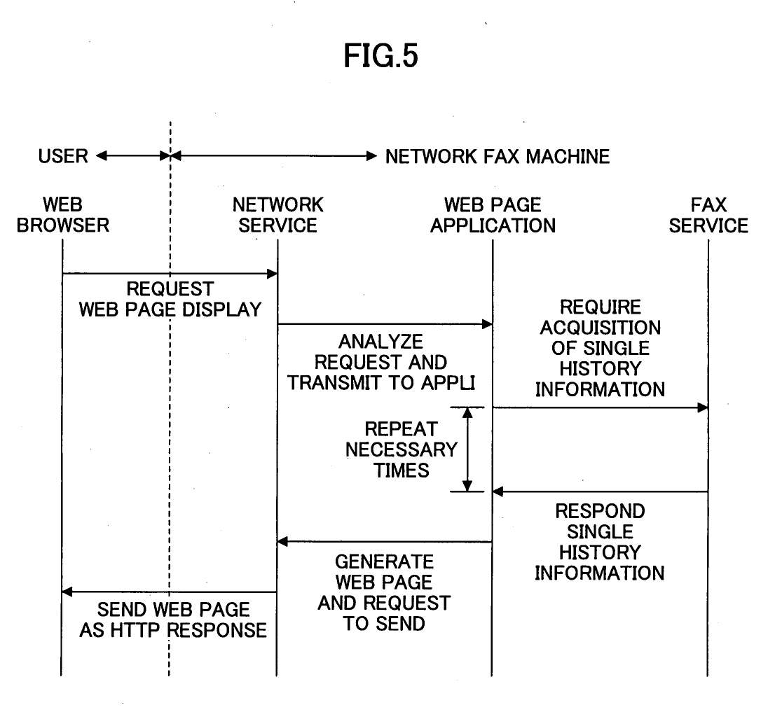

FIG. 5 is a timing chart showing an example of a sequence of an operation of software inside of the device and a Web browser at the user side, in a case where the Web page to be provided is a page where a list of the communications history of the fax machine is described.

First, the user requests display of the Web page where the list of the communications history of the fax machine is described to the network fax machine FX, by using the Web browser 30 contained in the user operating machine.

Inside of the network fax machine FX, the network service 20j receives the display request of the Web page from an external part of the device.

Here, the Web page application 20d may have a structure wherein a plurality of the Web page applications 20d exists inside of the network fax machine FX corresponding to types of the Web page to be provided.

The network service 20j analyzes the request message such as the URL of the requested Web page. The network service 20j also transfers the request to the proper Web page application 20d.

The Web page application 20d that receives the request requires the fax service 20i to send a single history information element.

The fax service 20i returns the single history information element to the Web page application 20d according to the request.

The Web page application 20d repeatedly requires to the fax service 20i to send the history information corresponding to the number of the request from the Web browser. After acquiring necessary history information, the Web page application 20d describes a single Web page where the information is collected in HTML and/or another language and requests the network service 20j to send the Web page to the Web browser 30.

The network service 20j sends the Web page to the Web browser 30 as a response of HTTP, corresponding to the requirement from the Web page application 20d.

In addition, the Web page application 20e provides an interface for acquiring a machine state or performing various settings, to exclusive client software installed in the user operating machine, by using the network service 20j and another services. As the interface, not SNMP or other original protocol but SOAP (Simple Object Access Protocol) using XML technology is used for the interface.

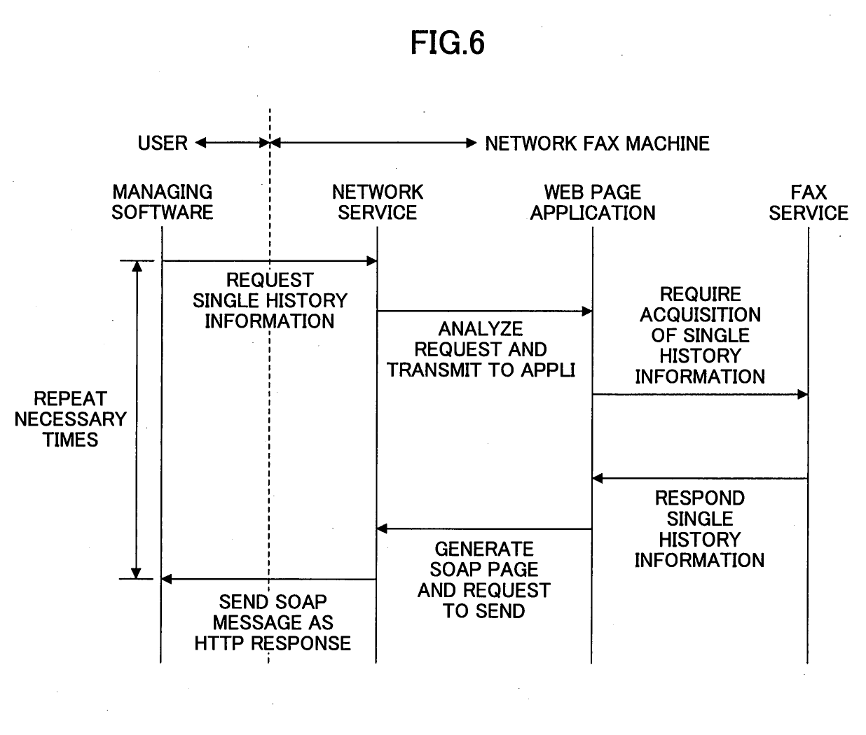

FIG. 6 is a timing chart showing an example of a sequence of an operation of the software inside of the device and managing software at the user side, in a case where the Web service to be provided has a function to provide communications history information of the fax machine.

The managing software at the user side requests the communication history information of a facsimile of a single case from the network fax machine FX. In the network fax machine FX, the network service 20j receives a request message of SOAP.

Here, a plurality of the Web service applications 20e may exist inside of the network fax machine FX, corresponding to types of the Web service to be provided. The network service 20j analyzes the received SOAP message and transmits the request to the proper Web service application 20e.

The Web service application 20e which receives the request for acquisition of the history information of a single case, sends the request to the fax service 20c.

The fax service 20c sends the history information of the single case to the Web service application 20e, corresponding to the request.

Based on the request, the Web service application 20e generates the history information as a response message of the SOAP and requires the network service 20j to send the message to the Web browser 40.

The network service 20j sends a response message of the SOAP to the managing software at the user side based on the requirement from the Web service application 20e.

In the managing software, for necessary numbers of cases, request of acquisition of the history information is repeatedly sent to the network fax machine FX.

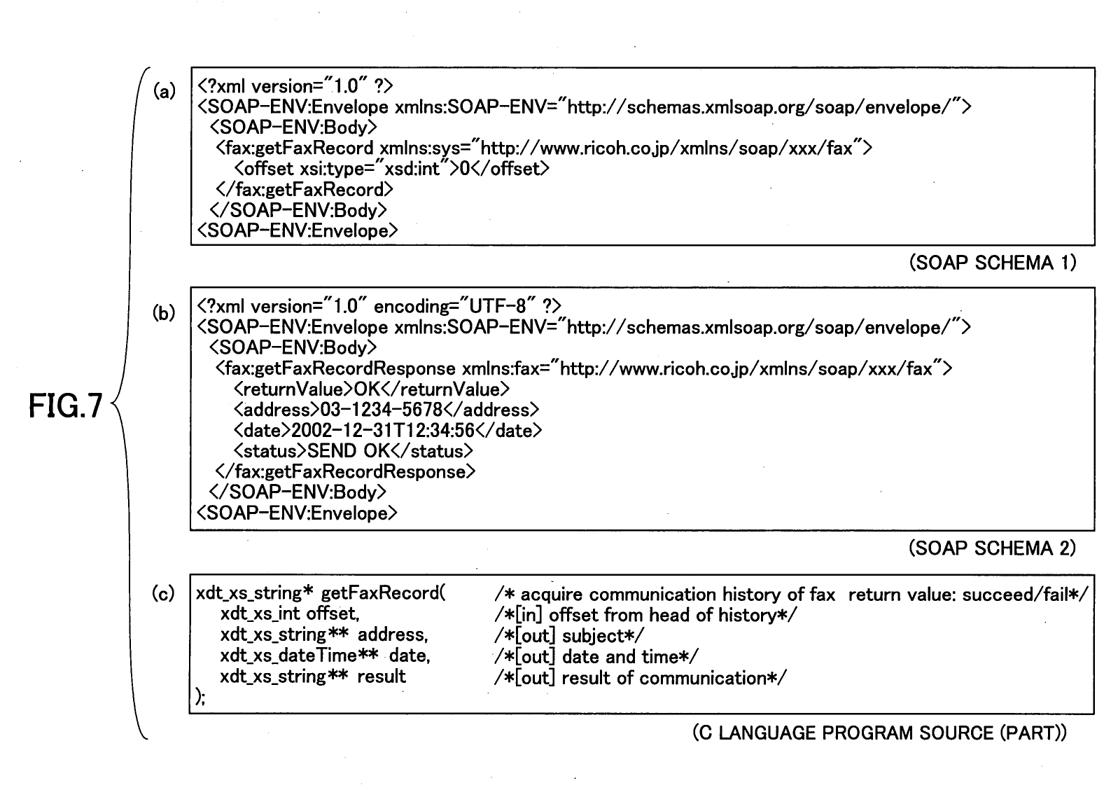

FIG. 7 is a schematic view showing examples where a request message (SOAP schema 1) sent from the user side to the device is shown in FIG. 7-(a), and a response message (SOAP schema 2) being a response from the device to the user side is shown in FIG. 7-(b), so as to exchange the SOAP messages when the history information of the facsimile is acquired.

Meanwhile, the SOAP is a well-known technology and may have the following advantage. That is, although the managing software is normally provided by a developer or seller of the device, if the way of the SOAP interface is opened to the public as WSDL (Web Service Description Language) or the like, it is possible for the user to refer to it and therefore develop client software by himself.

Referring to FIG. 7-(a), in the SOAP schema 1, the first line represents an XML declaration. The second line represents that XML data hereafter are SOAP messages. “http://˜” is a namespace URI (Uniform Resource Identifiers) representing that this XML data are SOAP envelopes. The third line represents that the SOAP body is represented at fourth through sixth lines.

The fourth through sixth lines represent that a method to request is “acquisition of facsimile communications history”. (“http://˜” is a namespace URI of this XML tag.) The fifth line designates a value of a parameter “offset from the head of the history” to be transmitted to the method.

Referring to FIG. 7-(b), in the SOAP schema 2, the first line is an XML declaration and represents that the character code system is UTF-8. The second line represents that XML data hereafter are SOAP messages. “http://˜” is a namespace URI (Uniform Resource Identifiers) representing that these XML data are SOAP envelopes. The third line represents that the SOAP body is represented at fourth through ninth lines.

The fourth through ninth lines represent that a method to request is “acquisition of facsimile communications history”. (“http://˜” is a namespace URI of this XML tag.) The fifth line represents that a return value of the method is “OK”. The sixth line represents that a subject of communication is “03-1234-5678”. The seventh line represents that a date of communication is “2002 year, December 31st, 12 o'clock 34 minutes 56 seconds”. The eighth line represents that a result of the communication is “completion of the communication”.

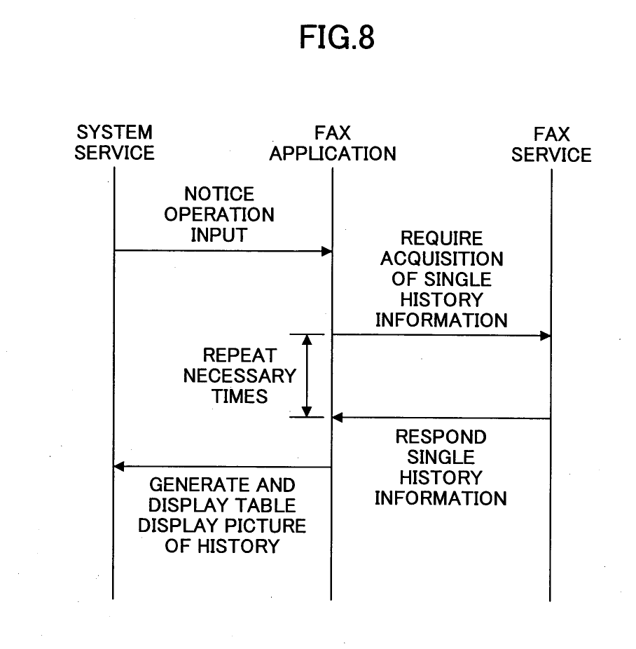

FIG. 8 is a timing chart showing an example of a sequence of an operation of fax application 20c, system service 20f, and fax service 20i in a case where the fax application 20c shows communications history information as a part of a function of the fax application 20c.

If the communications history button 7l in the liquid crystal display 7g having a touch panel of the operations display part 7 is touched, the system service sends a notice that the button is touched, with the touched coordinates to the fax application 20c.

The fax application 20c determines from the noticed coordinates that the touched button is the communications history button, so as to request the acquisition of the history information of the single case from the fax service 20i.

The fax service 20i returns the history information of the single case to the fax application 20c, corresponding to the requirement.

The fax application 20c repeatedly requires necessary numbers of cases of the acquisition of the history information to the fax service 20i, based on the way of a picture designated in advance. After the acquisition of the necessary numbers of cases of the history information is completed, the fax application 20c requires the system service 20f to display the history information on the liquid crystal display 7g having a touch panel in a format of a table.

In FIG. 7-(c), an example where a command (program interface) that a service layer provides to an application layer in this case is described in a function format of the C language. Here, a type name of a character string type parameter is defined as “xdt_xs_string”, a type name of an integer type parameter is defined as “xdt_xs_int”, and a type name of a date and time type parameter is defined as “xdt_xs_dateTime”.

This function is provided by the fax service 20i so that the application such as the fax application 20c acquires the communications history of the facsimile. In this function, the return value of the function, an input parameter, and an output parameter have formats conforming to the SOAP schemas 1 and 2 shown in FIG. 7-(a) and FIG. 7-(b) respectively.

This function has a single integer type parameter “offset” which designates offset from the head of the history, as a parameter for inputting. This function is called by setting a proper value to this parameter.

After the return from the function call, respective information is set to a character string type parameter “address” representing a subject, a day and time type parameter “date” representing a day and time of communication, and a character string type parameter “result” representing a communication result, which are parameters for outputting. Furthermore, whether the acquisition of the history information by the function call is successful is returned as a return value of the function, by using a character string “OK” or “NG”.

In a case where the Web page application 20d or the Web service application 20e and the fax application 20c, or the like provides information about a state of the machine to the user, the state of the machine is acquired by using a service providing the program interface.

At this time, the service provides only a single program interface without distinguishing whether an application using the program interface is the Web page application 20d, the Web service application 20e, or the application on the operations panel such as the fax application 20c.

Thus, it is not necessary for the service layer to have designed and installed different program interface for every application. In addition, since the program interface is unified in a format conforming to the SOAP schema, it is not necessary for the application to individually understand and have designed or installed methods of using the respective services when using the various services. Because of this, abilities to maintain and reuse the services are improved.

The present invention is not limited to these embodiments, but variations and modifications may be made without departing from the scope of the present invention.

For example, although an example where the present invention is applied to the network fax machine FX is explained in the above-discussed embodiment, the present invention may be applied to other type of terminal devices having the substantially same user interface means.

This patent application is based on Japanese Priority Patent Application No. 2003-289310 filed on Aug. 7, 2003, the entire contents of which are hereby incorporated by reference.

What is claimed is:

1. A network terminal device having a Web service function, comprising:
means for providing a Web page to a user via a network; and
means for providing a Web service using SOAP to the user via the network.

2. The network terminal device as claimed in claim 1, wherein the network terminal device has a system structure including:
a first service layer for managing a hardware of a machine;
an application layer for providing an operations display function of the machine to the user by using the first service layer; and
a second service layer having a function call conforming to a SOAP schema or a program interface to the application layer.

3. The network terminal device as claimed in claim 2, wherein the means for providing the Web page uses the second service layer.

4. The network terminal device as claimed in claim 2, wherein the means for providing the Web service uses the second service layer.

5. A network terminal device having a Web service function, comprising:
user interface function means for providing an operations display function to a user via a network; and
means for providing a Web page via the network.

6. The network terminal device as claimed in claim 5, wherein the network terminal device has a system structure including:
a first service layer for managing hardware of a machine;
an application layer for providing an operations display function of the machine to the user by using the first service layer; and
a second service layer having a function call conforming to a SOAP schema or a program interface to the application layer.

7. The network terminal device as claimed in claim 6, wherein the means for providing the Web page uses the second service layer.

8. The network terminal device as claimed in claim 6, wherein the application layer includes:
a copy application function for providing a user interface of a copy function on an operations panel;
a fax application for providing a user interface of a fax function on the operations panel;
a printer application for providing a user interface of a printer function on the operations panel, and
wherein the copy application function, the fax application function, and the printer application function use the second service layer.

9. A network terminal device having a Web service function, comprising:
user interface function means for providing an operations display function to a user via a network; and
means for providing a Web service using SOAP to the user via the network.

10. The network terminal device as claimed in claim 9, wherein the network terminal device has a system structure including
a first service layer for managing hardware of a machine;
an application layer for providing an operations display function of the machine to the user by using the first service layer; and
a second service layer having a function call conforming to a SOAP schema or a program interface to the application layer.

11. The network terminal device as claimed in claim 10, wherein the means for providing the Web service uses the second service layer.

12. The network terminal device as claimed in claim 10, wherein the application layer includes:
a copy application function for providing a user interface of a copy function on an operations panel;
a fax application for providing a user interface of a fax function on the operations panel; and
a printer application for providing a user interface of a printer function on the operations panel, and
wherein the copy application function, the fax application function, and the printer application function use the second service layer.

13. A network terminal device having a Web service function, comprising:
user interface function means for providing an operations display function to a user via a network;
means for providing a Web page to the user via the network; and
means for providing a Web service using SOAP to the user via the network.

14. The network terminal device as claimed in claim 13, wherein the network terminal device has a system structure including
a first service layer for managing hardware of a machine;
an application layer for providing an operations display function of the machine to the user by using the first service layer; and
a second service layer having a function call conforming to a SOAP schema or a program interface to the application layer.

15. The network terminal device as claimed in claim 14, wherein the means for providing the Web page and the means for providing Web service use the second service layer.

16. The network terminal device as claimed in claim 14, wherein the application layer includes:
a copy application function for providing a user interface of a copy function on an operations panel;
a fax application for providing a user interface of a fax function on the operations panel; and
a printer application for providing a user interface of a printer function on the operations panel, and
wherein the copy application function, the fax application function, and the printer application function use the second service layer.

17. A network terminal device having a Web service function, comprising:
a Web page providing part configured to provide a Web page to a user via a network; and
a Web service providing part configured to provide a Web service using SOAP to the user via the network.

18. The network terminal device as claimed in claim 17, wherein the network terminal device has a system structure including:
a first service layer configured to manage hardware of a machine;
an application layer configured to provide an operations display function of the machine to the user by using the first service layer; and
a second service layer having a function call conforming to a SOAP schema or a program interface to the application layer.

19. The network terminal device as claimed in claim 18, wherein the Web page providing part uses the second service layer.

20. The network terminal device as claimed in claim 18, wherein the Web service providing part uses the second service layer.

21. A network terminal device having a Web service function, comprising:
a user interface functional part configured to provide an operations display function to a user via a network; and
a Web page providing part configured to provide a Web page via the network.

22. The network terminal device as claimed in claim 21, wherein the network terminal device has a system structure including:
a first service layer configured to manage hardware of a machine;
an application layer configured to provide an operations display function of the machine to the user by using the first service layer; and
a second service layer configured to have a function call conforming to a SOAP schema or a program interface to the application layer.

23. The network terminal device as claimed in claim 22, wherein the Web page providing part uses the second service layer.

24. The network terminal device as claimed in claim 22, wherein the application layer includes:
a copy application function for providing a user interface of a copy function on an operations panel;
a fax application function for providing a user interface of a fax function on the operations panel;
a printer application function for providing a user interface of a printer function on the operations panel, and
wherein the copy application function, the fax application function, and the printer application function use the second service layer.

25. A network terminal device having a Web service function, comprising:
a user interface functional part configured to provide an operations display function to a user via a network; and
a Web service providing part configured to provide a Web service using SOAP to the user via the network.

26. The network terminal device as claimed in claim 25, wherein the network terminal device has a system structure including
a first service layer configured to manage hardware of a machine;
an application layer configured to provide an operations display function of the machine to the user by using the first service layer; and
a second service layer having a function call conforming to a SOAP schema or a program interface to the application layer.

27. The network terminal device as claimed in claim 26, wherein the Web service providing part uses the second service layer.

28. The network terminal device as claimed in claim 26, wherein the application layer includes:
a copy application function for providing a user interface of a copy function on an operations panel;
a fax application for providing a user interface of a fax function on the operations panel; and
a printer application for providing a user interface of a printer function on the operations panel, and
wherein the copy application function, the fax application function, and the printer application function use the second service layer.

29. A network terminal device having a Web service function, comprising:
a user interface functional part configured to provide an operations display function to a user via a network;
a Web page providing part configured to provide a Web page to the user via the network; and
a Web service providing part configured to provide a Web service using SOAP to the user via the network.

30. The network terminal device as claimed in claim 29, wherein the network terminal device has a system structure including
a first service layer configured to manage hardware of a machine;
an application layer configured to provide an operations display function of the machine to the user by using the first service layer; and
a second service layer having a function call conforming to a SOAP schema or a program interface to the application layer.

31. The network terminal device as claimed in claim 30, wherein the Web page providing part and the Web service providing part use the second service layer.

32. The network terminal device as claimed in claim 30, wherein the application layer includes:
a copy application function for providing a user interface of a copy function on an operations panel;
a fax application for providing a user interface of a fax function on the operations panel; and
a printer application for providing a user interface of a printer function on the operations panel, and
wherein the copy application function, the fax application function, and the printer application function use the second service layer.

33. A method for managing equipment by using a Web technology, comprising the steps of:
a) providing a Web page to a user via a network; and
b) providing a Web service using SOAP to the user via the network.

34. A method for managing equipment by using a Web technology, comprising the steps of:
a) providing an operations display function to a user via a network; and
b) providing a Web page via the network.

35. A method for managing equipment by using a Web technology, comprising the steps of:
a) providing an operations display function to a user via a network; and
b) providing a Web service using SOAP to the user via the network.

36. A method for managing equipment by using a Web technology, comprising the steps of:
a) providing an operations display function to a user via a network;
b) providing a Web page to the user via the network; and
c) providing a Web service using SOAP to the user via the network.
